(19) United States
(12) Patent Application Publication
(10) Pub. No.: US 2023/0240174 A1
(43) Pub. Date: Aug. 3, 2023

(54) SEED DISPENSING DEVICE FOR SOWING MACHINES

(71) Applicant: GUSTAVO ALEJANDRO BOETSCH, Cordoba (AR)

(72) Inventor: GUSTAVO ALEJANDRO BOETSCH, Cordoba (AR)

(21) Appl. No.: 18/052,991

(22) Filed: Nov. 7, 2022

(30) Foreign Application Priority Data
Feb. 2, 2022 (AR) N20220100209

(51) Int. Cl. A01C 7/10; A01C 7/20; A01C 15/18

(52) U.S. Cl. CPC A01C 7/105; A01C 7/20; A01C 15/18

(57) ABSTRACT

A seed dispensing device for sowing machines that allows a continuous and synchronized sowing of seeds, depositing the seeds at the same separation distance, optimizing and thus providing a better sowing operation.

### FIELD OF THE INVENTION

The present invention relates to the field of devices, means and arrangements used in agroindustry, more particularly in the sowing machines, and more preferably it refers to a seed dispensing device or seed metering device which, unlike conventional metering devices, allows the grain to fall from the discharge conduit or pipe to the furrows in a constant and synchronized manner without there being alterations between the distances of seed sowing.

### DESCRIPTION OF PRIOR ART

It is well known in the field of art that sowing machines comprise a chassis or main structure on which different components are assembled, such as set of conveyor wheels, central seed hopper, secondary hopper to supply the seed dispensing devices, sowing body mounted on a pipe transverse to the chassis, air blowing or suction turbine and other elements that are well known in the art and that for such reasons we will not go into descriptive details.

Regarding seed dispensing devices, there are seed dispensing devices of pneumatic nature that have a rotating plate that separates it into a negative pressurization or suction chamber and an operational chamber. Generally, seeds enter through a feed inlet, accumulate in a sector, are deposited on a few cavities provided on the plate and remain housed thanks to negative pressurization or suction generated by the vacuum chamber. Then, they reach a sector where the suction or negative pressurization is zero, falling by gravity to a discharge conduit and then to the furrow.

In turn, there is also a horizontal plate mechanical dispensing device used in sowing machines of coarse grains, furrow by furrow with minimum tillage (direct) and in conventional sowing, and with seed feeding by means of a gravity fall system or by air stream (seeds dragged by a positive air stream to the secondary hopper). Furrow seeding machines are designed to place the seeds some distance apart according to each type of seed. The sowing machines require depositing the seeds in the soil at a desired depth and with a uniform distribution among them. The sowing machine consists of a main hopper with a large load capacity, from which discharge hoses go down to the secondary hoppers where they receive seeds and the grain metering device dispenses them uniformly.

A horizontal plate mechanical seed metering device has a rotating plate located in the lower part of the secondary hopper. The plate is provided with cells called cavities which are evenly distributed in which seeds shall be retained. During its operation, the sowing plate is rotated on the counter plate and the dispensing device causes seeds that are contained in the cavities to enter. The leveling triggers regulate the entry of seed into the dispensing device, and the ejecting triggers let seeds fall on the discharge area of the counter plate and from here seeds fall by gravity through the discharge pipe towards the furrow.

Although Conventional seed metering or dispensing devices of the prior art have proven to work in practice, a number of drawbacks still occur. One of them is related to the fall of grain from the discharge pipe or conduit towards the respective furrow. At present, the continuous synchronization in the fall of grain from the discharge pipe to the furrow depends on the mechanism of the seed metering device, which has been previously described.

In practice, it usually happens that not always the fall of grain towards the furrow is carried out in a synchronized or constant way, many times certain misadjustments or interruptions occur between the fall of one seed and another seed. The misadjustments usually occur due to the collision of the seeds against the inner wall of the discharge pipe, causing any synchronization achieved by the seed metering device to be lost. Also, it may happen that due to the collision of the seeds against the inner wall of the pipe, a desynchronization occurs that causes two seeds to fall very close to each other and not at the correct distance at which they should be sown. Consequently, the distance between the sown seeds does not remain constant and this brings with it a great problem in relation to sowing regularity. On the other hand, it may happen that there is no grain fall from the discharge pipe due to its absence in the respective plate or related mechanism of the grain dispensing device; this being another drawback since sowing regularity would be lost. Both the lack of synchronization or interruption in the grain fall, as well as its absence in the respective metering device, are inconvenient in practice that have not yet been solved effectively.

By virtue of the current state of the art available for seed metering in the agroindustry, it would be very convenient to have a new arrangement being constituted and constructed to allow a fall of grain from the discharge pipe to the furrow in a synchronized and constant manner, without there being the drawbacks mentioned above.

### BRIEF DESCRIPTION OF THE INVENTION

It is therefore an object of the present invention to provide a new seed dispensing device for sowing machines that allows the grain to fall from the discharge tube to the furrow, in a constant and synchronized manner.

It is also the object of the present invention to provide a seed dispensing device having a dispensing device that provides seeds in a constant manner.

It is also another object of the present invention to provide said metering device which is made to operate in a synchronized manner, guaranteeing constant seed fall without alterations or misadjustments or interruptions.

It is another object of the present invention to provide a metering device with synchronized double feed to allow constant falling of the seed.

It is also another object of the present invention to provide a seed dispensing device for sowing machines, of the type comprising a seed feeding inlet in communication with a seed container through which a seed metering device takes the seeds and discharges them into a discharge conduit whose outlet port is oriented towards the respective furrow previously made on the surface, wherein said dispensing mechanism comprises a pair of rotating plates independent form each other which are driven through a respective rotating shaft which, in turn, is driven through an electric motor, a plurality of arms radially arranged on the perimeter of each rotating plate, which have a distal end provided with at least one seed collecting means, at least two central gears independent from each other, rotably mounted between said rotating plates and driven by means of the corresponding rotating shaft, at least two parallel seed conveyors chains which are independent from each other, mounted on said central gears from which they extend in the form of a closed loop along the discharge conduit to the outlet port, and at least a pair of secondary conduits having a metered seed inlet and a metered seed outlet which is oriented towards the respective conveyor chain providing at least one pair of sensors arranged adjacent to each side of said seed conveyor chains.

It is still another object of the present invention to provide a seed dispensing device for sowing machines, comprising:

a seed feeding inlet in communication with a seed container capable of housing seeds to be sown into a furrow previously made on a seeding surface;

a seed metering device in communication with a discharge conduit, the discharge conduit having an outlet port which is oriented towards said furrow,

at least two parallel and independent seed conveyor chains, each one of the at least two parallel and independent seed conveyor chains being mounted on a corresponding independent central gear, with each one of the at least two parallel and independent seed conveyor chains forming a closed loop, wherein the at least two parallel and independent seed conveyor chains being adjacent to each other to extend, along a part of the closed loop, within the discharge conduit up to the outlet port of the discharge conduit,

at least one pair of seed sensors; each seed sensor of said at least one pair of seed sensors arranged adjacent to a respective one of each side of said at least two parallel and independent seed conveyor chains, with each seed sensor being capable of detecting presence of seeds in said at least two parallel and independent seed conveyor chains,

at least one electronic controller in communication with at least one sowing monitor and with a furrow module;

wherein said sowing monitor is provided with at least one sowing profile, map or parameter, whose sowing operating characteristics are sent to said electronic controller so that the latter, based on the sowing operating characteristics requested and dependent on each type of seeding, sends a corresponding signal to said furrow module which will send its respective activation or drive signal to a pair of electric motors, each of which selectively rotates a corresponding rotating plate, thus allowing to carry out the process of sowing through the corresponding driven seed conveyor chain, and

wherein said discharge conduit is provided with seeds by said at least two parallel and independent seed conveyor chains in a manner that when one of said at least two parallel and independent seed conveyor chains has no seed in a position at said outlet port, the other one of said at least two parallel and independent seed conveyor chains discharges the seed housed in the other one of said at least two parallel and independent seed conveyor chains.

### BRIEF DESCRIPTION OF DRAWINGS

For greater clarity and understanding of the object of the present invention, it has been illustrated in several figures, in which the invention has been represented in one of the preferred embodiments, all by way of example, wherein:

FIG. 1 shows a perspective vies of the seed dispensing device of the present invention, wherein it has been illustrated on a transparent basis to show its interior;

FIG. 2 shows a perspective and transparent view of the interior of the seed dispensing device of the present invention, wherein the parts comprising it can be observed;

FIG. 3 shows a perspective and partial view of a metering device of the seed dispensing device according to the present invention;

FIG. 4 shows still a perspective and partial view of the metering device according to the present invention;

FIG. 5 shows still another perspective and partial view of the metering device of the present invention;

FIG. 6 shows a view even a perspective and partial view of the metering device according to the present invention, in which one can observe a pair of rotating blades that are discarding two seeds according to one of the possible application forms of the present invention;

FIG. 7 shows a perspective and partial view of the lower end of a discharge conduit according to the present invention, where it has been illustrated on a transparent basis to allow the visualization of the parts that are arranged therein;

FIG. 8 shows a perspective view of an alternative embodiment of the device of the invention wherein a seed spraying system, comprising liquid sprayers and sprinklers, is provided to apply a product such as an inoculant or other product to the seeds in the zone where the seeds are dropped into the furrow, and

FIG. 9 is a perspective view of the embodiment of FIG. 8, wherein an outlet port or outlet protector has been removed for clarity purposes, and

FIG. 10 shows an exploded perspective view of an alternative embodiment of the dispensing device of the present invention, wherein two metering parts or modules A and B have been referenced, by way of example;

FIG. 11 shows a schematic diagram of a control electronics used with the alternative embodiment of FIG. 10;

FIG. 12 shows a perspective view of another preferred embodiment of the dispenser according to the present invention;

FIG. 13 shows a view of the interior of the dispensing device of FIG. 12 and in accordance with the present invention;

FIG. 14 shows yet another perspective view of the dispensing device of FIG. 12;

FIG. 15 shows a view of an upper portion of the dispensing device of FIG. 12 and in accordance with the present invention;

FIG. 16 shows a side view of the upper portion of the dispensing device of FIG. 15;

FIG. 17 shows another perspective view of the upper portion of the dispensing device according to FIG. 12;

FIG. 18 shows another perspective and enlarged view of the upper portion of the dispensing device according to FIG. 12; and

FIG. 19 shows an enlarged perspective view of a lower portion of the dispensing device of FIG. 12.

### DETAILED DESCRIPTION OF THE INVENTION

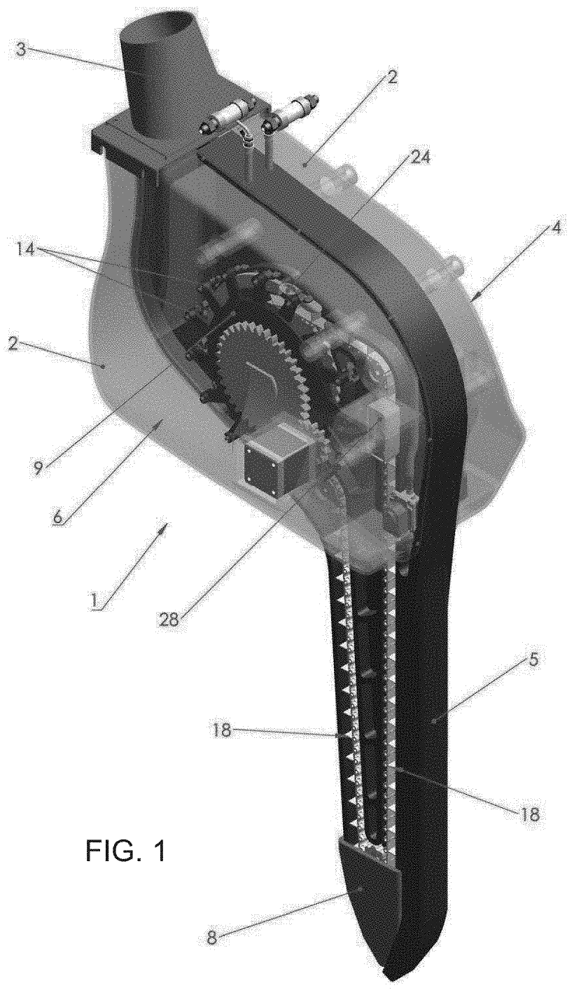

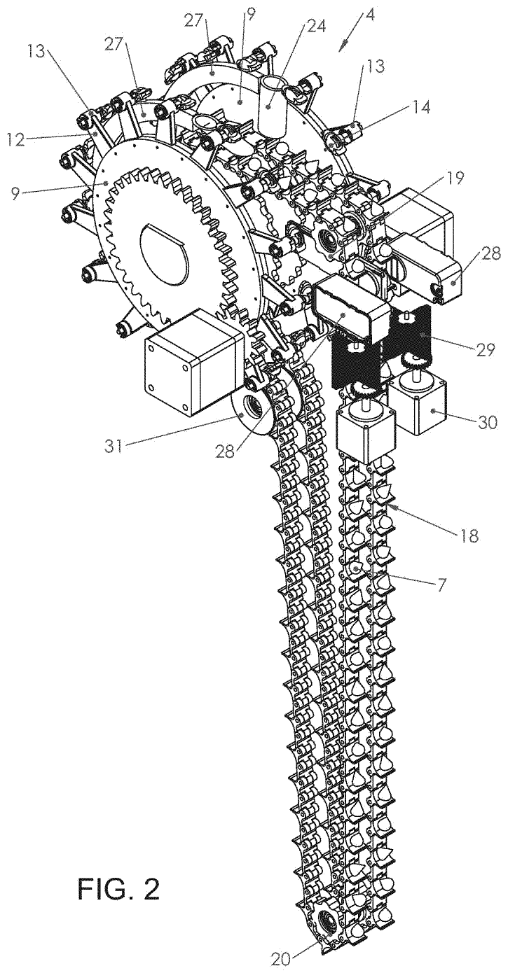

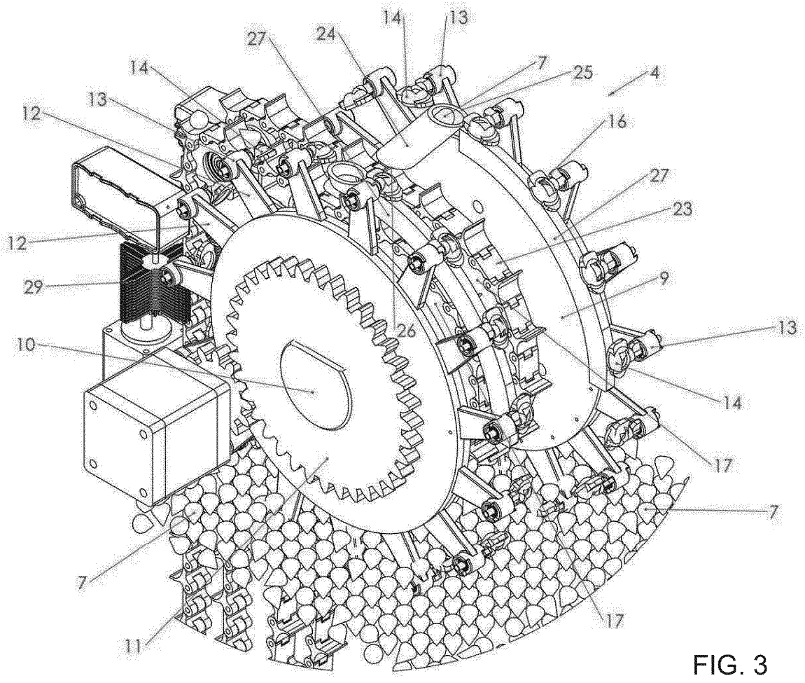

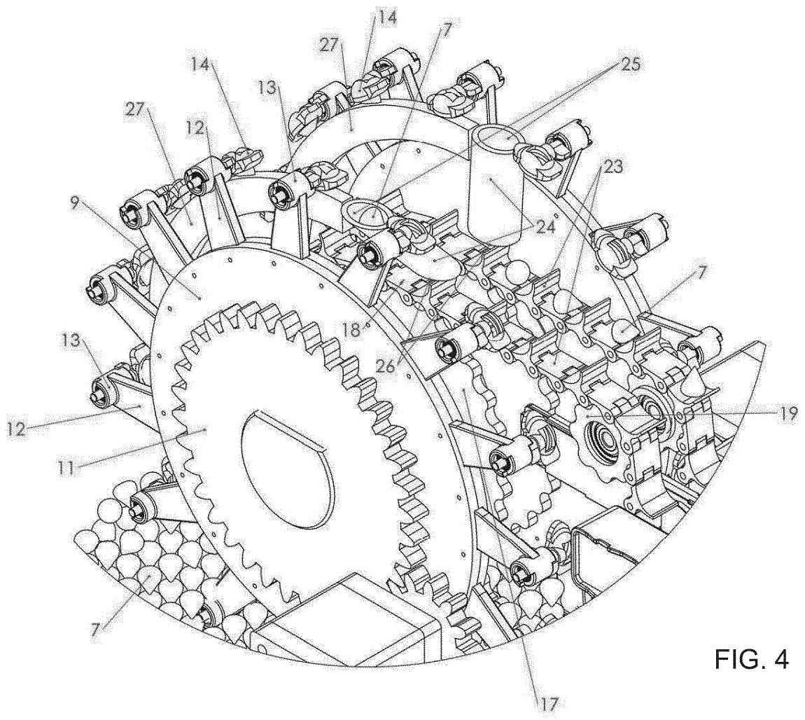

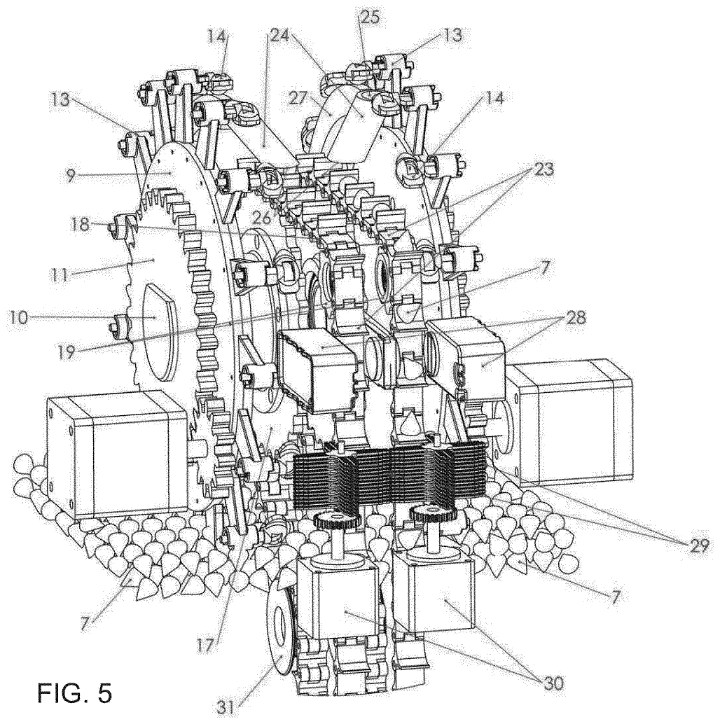

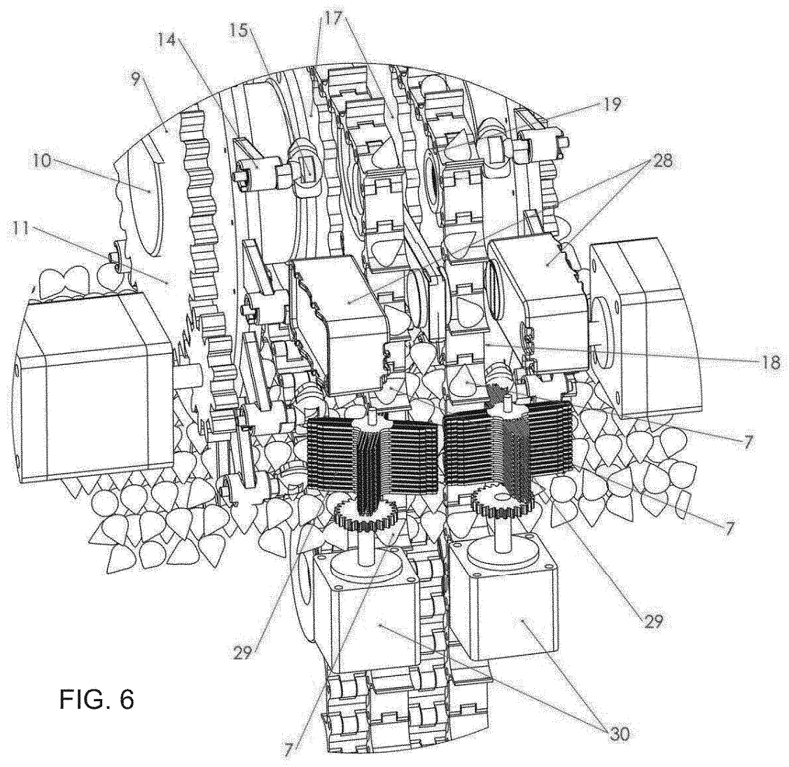

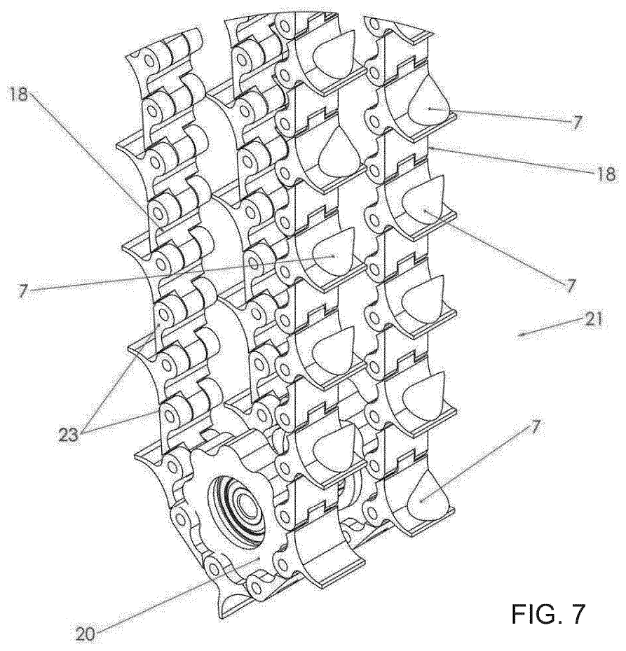

Referring now to the figures, it is seen that the invention consists of a new seed dispensing device for sowing machines that allows a continuous and synchronized sowing of seeds, depositing the seeds at the same separation distance, optimizing and thus providing a better sowing operation. Thus, and according to FIGS. 1 to 7, the seed dispensing device of the present invention is indicated by the general reference 1 and comprises two caps 2, a seed feeding inlet 3, a metering device 4 provided with a feeding device and a discharge conduit 5 or well known in the art as “sword”. The feeding device, which will be described below, is responsible for placing the seeds in the metering device 4. A seed container 6 is arranged in the lower part of the dispensing device 1 so as to accumulate seeds 7 coming from the inlet 3, which will then be metered through the metering device 4 which takes the seeds from the feeding device and discharges them into the discharge pipe which outlet port 8 is oriented towards the respective furrow previously made on the surface.

Regarding the metering device 4, and more particularly the feeding device, it comprises a pair of independent rotating plates 9 which are arranged in parallel, spaced from each other and which are driven through the rotation of a respective rotating shaft 10 which in turn is driven through a set of gears 11 and electric motor (not illustrated). Each rotating plates 9 has on its perimeter a plurality of arms 12 arranged radially, which have a distal end 13 provided with at least one seed collecting means 14 which may comprise an access window or port 15 extending forming a container 16 which receives and partially houses a seed 7 taken from the seed container 6. The shape and dimensions of each container 16 allow single seed housing avoiding an overfeeding that could damage the continuous sowing process. In turn, the angle or position with which the collecting means are arranged will be such as to allow the taking and unloading of the seed without it falling according to what will be described below. It is further emphasized that the feeding device is not limited to that described above, but that other types of feeding devices can be considered and used in the present invention without any inconvenience.

On the other hand, the present invention provides at least two central gears 17 independent from each other, rotably mounted between said rotating plates 9 and driven by means of the corresponding rotating shaft 10, which in turn, drives the corresponding rotating plates 9. Likewise, there are at least two seed conveyor chains 18 parallel and independent from each other, mounted on said central gears 17 from which they extend in the form of a closed loop along, and inside, the discharge conduit 5 to the outlet port 8. The extension of the seed conveyors chains towards the discharge conduit 5 is carried out in a guided manner thanks to the arrangement of a pair of guide rollers 19. In turn, the conveyor chains 18 are guided in closed way and adjacent to the area of the outlet port, inside the discharge conduit through a lower roller 20, being guided in turn, prior to the dispensing device and from the discharge conduit, through a roller 31. In this way, the conveyor chains 18 move along a closed loop between the interior of the dispensing device and the discharge conduit.

Each conveyor chain 18 has a seed receiving face 21 which comprises a plurality of wedge-shaped links or sections 23 in which central portion there is provided a seed receiving seat 22. The wedge shape of each section 23 allows having contiguous and delimited spaces to temporarily store a single seed in each of them. On the other hand, the present invention is provided with at least a pair of secondary conduits 24 having a metered seed inlet 25 that receives the seeds housed in the collecting means 14 and a metered seed outlet 26 which is oriented towards the respective conveyor chain, more particularly towards the seed receiving face 21. Wherein, said secondary conduits 24 are arranged inclined above the central gears 17, with each access window or port 15 of the collecting means 14 passing adjacent thereto.

To prevent the seed from falling when being picked up by the collecting means 14 until it is discharged into the respective secondary conduit 24, there is provided a pair of curved seed guides 27 each extending from the metered seed inlet 25 of the secondary conduit 24 to a lower portion in a circumferential manner. The radius of curvature and the location of each curved guide 27 allow, in combination with the position angle of each seed collecting means 14, the seeds to move tangentially to the path of the curve defined by the guide 27. That is to say, access ports or windows of the collecting means pass in a slightly flush manner to said guides 27, preventing the seeds from frilling until they reach the metered seed inlet 25 of each secondary conduit 24.

Likewise, the dispensing device of the present invention presents a pair of sensors 28 arranged adjacent to each side of said seed conveyor chains 18. The sensors 28 make it possible to identify whether the corresponding section 23 of the conveyor chain 18 has at least one seed 7. In case of having two seeds 7 together in a same section 23 of the conveyor chain, there are provided two rotating blades 29 acting as overloaded seed ejectors arranged on each side of the conveyor chains and below the sensors 28, said rotating blades 30 are driven by an electric motor 30. When the sensor 28 detects that there are two or more seeds in the same section 23, the electric motor 30 is driven to rotate the blade 29 one-quarter length and the latter discards both seeds 7, the section 23 being “empty”.

As an alternative, not illustrated because it is a well-known mechanical device, an electric actuator can be arranged on each side of the chains instead of the blades. The actuator itself may consist of a cylinder and retractable/extensible stem driven, for example, by a solenoid mechanism. The aim of the extendable stem is to eject seeds from a cell or link of the corresponding chain. The concept is that, according to the invention, since there are two chains in parallel, it is preferable to have an empty cell than a cell overloaded with two or more seeds. The empty cell of one of the chains will be detected and the chain will be stopped in the unloading position while the other chain is put into operation.

It is emphasized that said sensors and electric motors are connected to a computerized central unit (not illustrated), which in turn indicates on a monitor the different sowing parameters and the information in real time of what is being sown. In addition, electric motors responsible for driving the rotating blades and their chains are also controlled by the computerized central unit that regulates their speed based on previously loaded maps that represent the characteristics of the ground. Said computer, in turn, can be assisted by a GPS system with high positioning accuracy.

Thus, the seed dispensing device of the present invention is constituted and constructed, which allows a seed discharge in a constant and synchronized way, without altering the sowing distance between seeds. This is due to the arrangement of the two conveyor chains, which are operated completely independently depending on the circumstance, in combination with sensors and rotating blades. Thus, the present invention notably allows a better precision, reliability and greater efficiency in the grain placing and spacing in the furrow. It is noted that, the invention makes an electronic tracking of each seed and position until it is placed in the furrow, since for the electronics used in the present invention, the conveyor chains are a division of lockers—links—consecutive and numbered sections that have each a seed, several or none, and act accordingly.

In an exemplary but not limitative mode for the present invention, the dispensing device of the invention can operate in the following manner: at the start of the sowing time, one of the rotating plates 9 initiates the continuous loading of seeds and their metering in the ground, meanwhile the other rotating plate 9 loads seeds 7 on the chain 18 to the last position of the conveyor chain in the discharge conduit or sword 5 prior to the fall of the seed, at which point it stops. In the latter case, this positioning is achieved by counting the passage of a known quantity of seeds that corresponds to the amount that the chain can house between the position in which the seed sensor 28 is and the end of the discharge conduit or outlet port 8. In order to carry out the seed loading 7, the rotating plate 9 rotates allowing each collecting means 14 to pick up a seed 7 from the seed container. While rotation continues, the conveyed seed passes through the seed guide 27 and falls into the metered seed inlet 25 of the secondary conduit 24 passing therethrough and falling into a section 23 of the conveyor chain 18.

In the case of a missing seed 7 in one of the sections 23 of the conveyor chain 18 of the rotating plate that is dosing seeds towards the furrows, this is detected by the seed sensor 28. When the absence of seed is detected, the rotating plate is stopped by starting the continuous dosing movement on the other rotating plate 9 in order to replace the missing seed in the conveyor chain of the first plate. In this circumstance, the process of positioning the first rotating plate 9 with seeds 7 on its chain until the end of the sword is started, being prepared for the eventual missing of seeds in the second rotating plate 9 Which is now dosing and being sensed by the respective seed sensor 28.

In the event that two or more seeds appear in the same link or section 23 of the conveyor chain, this status is detected by the sensors 23 which activate the movement into a quarter turn of the electric motor 30 integral with the rotating blades 29 which are seed ejectors that discard the two seeds present in the link of the conveyor chain and the sequence of replacement of that position is launched as if it were a case of seed shortage. That is, by discarding the two seeds, the sensor sends a signal to the computerized central unit so that section 23, which had the two seeds, is considered empty. When said section 23 is considered empty, the dispensing device operates as if the respective conveyor chain did not have any seed as described above.

In this way, there are two conveyor chains that allow the continuous metering of seeds towards the furrows. If one section or link of one of the conveyor chains is empty, the other chain already pre-loaded with seeds is driven to continue with the metering, allowing the chain 18 that had no seeds to position a section with seed subsequent to the one which was empty, adjacent to the outlet port 8, so as to allow metering in case the conveyor chain 18 that is currently in motion has some empty link or section. That is, the drive of the conveyor chains is mutually compensated in case they have an empty section, or with two seeds that were previously discarded by the rotating blades 29. The continuous metering of seeds is also achieved thanks to sensors 28 that constantly sense each link or section of the conveyor chains. Also, thanks to the secondary conduits 24-guides 27, the loading of a single seed per section 23 is ensured.

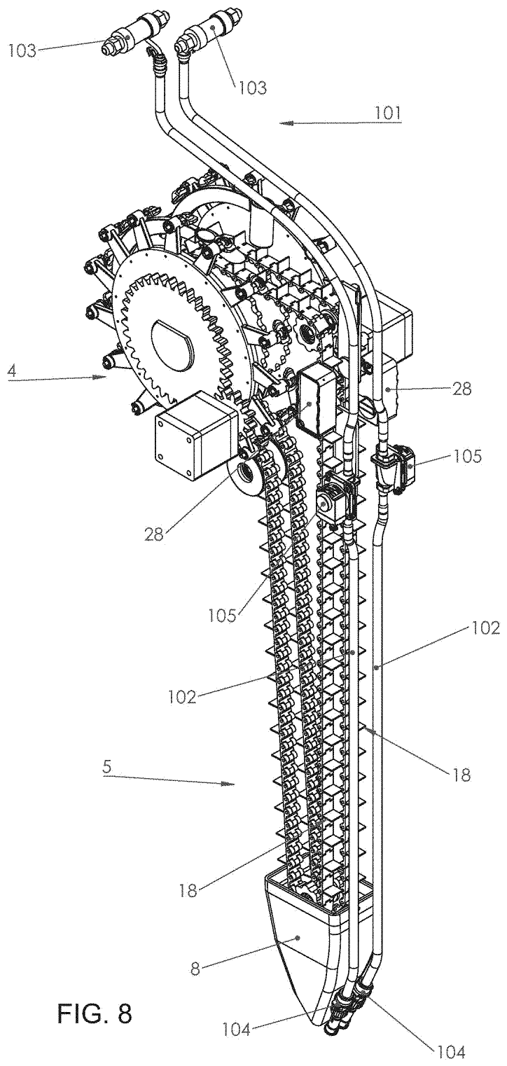

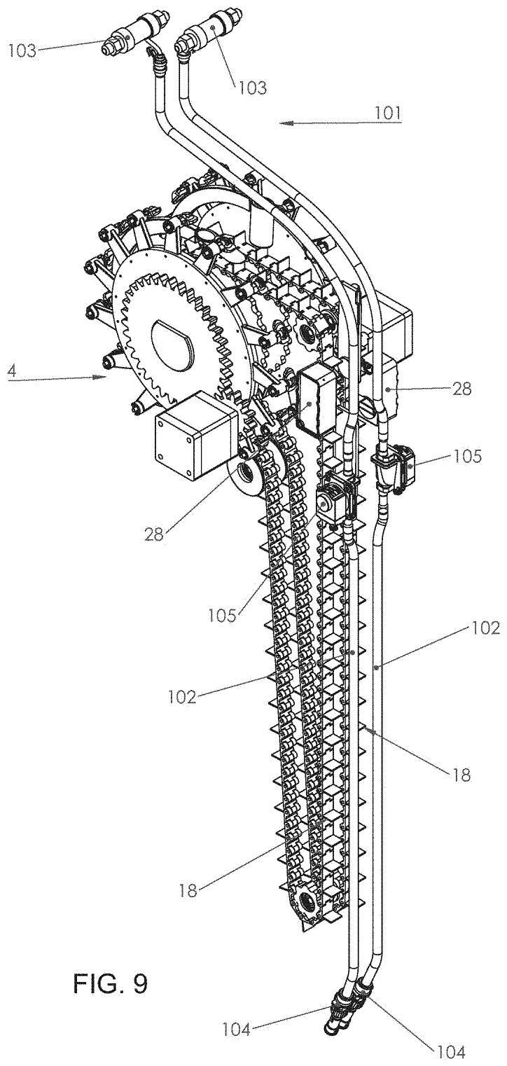

In a second embodiment shown in FIGS. 8, 9, the invention provides a seed spraying system 101, including liquid sprayers and sprinklers, comprising two or four product, such as liquid, liquid conveying conduits 102 extending parallel or along the seed dispensing device or seed metering device of the invention, from an upper portion of metering device 4 up to outlet port 8 of discharge conduit 5. More particularly, each of conduits 102 extends parallel or close to seed conveyor chains 18. Conduits 102 are connected, at the upper part thereof, by connection sleeves 103, to two or four circuits connected in turn to external containers containing agrochemical products or fertilizing products. At least an electro-valve 105 is mounted in an intermediate length of each conduit 102 and at least two or four ejecting nozzles 104, for spraying a treating product, are located at a lower end of discharge conduit 5, close to outlet port 8. Nozzles 104 are arranged close to the end of chain 18 run.

Seed spraying system 101 provides the spraying of each seed with an agrochemical and/or fertilizing product. To this purpose, electro-valves 105 receive an activation signal from a central computer unit which, based in the agronomic characteristics of the soil and the spraying product, activates the corresponding electro-valve 105 which in turn actuates the corresponding nozzle 104 to spray the corresponding product. The computer unit has the information, at all times, about which chain is dispensing the seeds. Thus the product is sprayed on the next seed or the seed that is being dispensed.

In this manner, the invented seed spraying system provides 101 provides the individual spraying of one or more treating products of different nature, such us agrochemicals or fertilizers, close to or onto each seed, thus preventing spraying the products over the soil as it occurs with conventional systems. Because the spraying is “punctual” onto each seed, no possibilities exist of generating “clouds” of the agrochemical product sprayed in the environment, avoiding thus the environmental contamination in areas around the seeding. This differs from the conventional methods which are well known in the art. It is clear that the term “agrochemical” must be understood as being any product employed in the agriculture and which is well known in the art, such as emerging agrochemicals and/or inoculants.

Seed spraying system 101 operates synchronically with the conveyor chains and the dispensing and metering device of the invention, thus optimizing the amount of treating product by hectare, thus increasing the benefits and advantages mentioned above in connection to seeding operations.

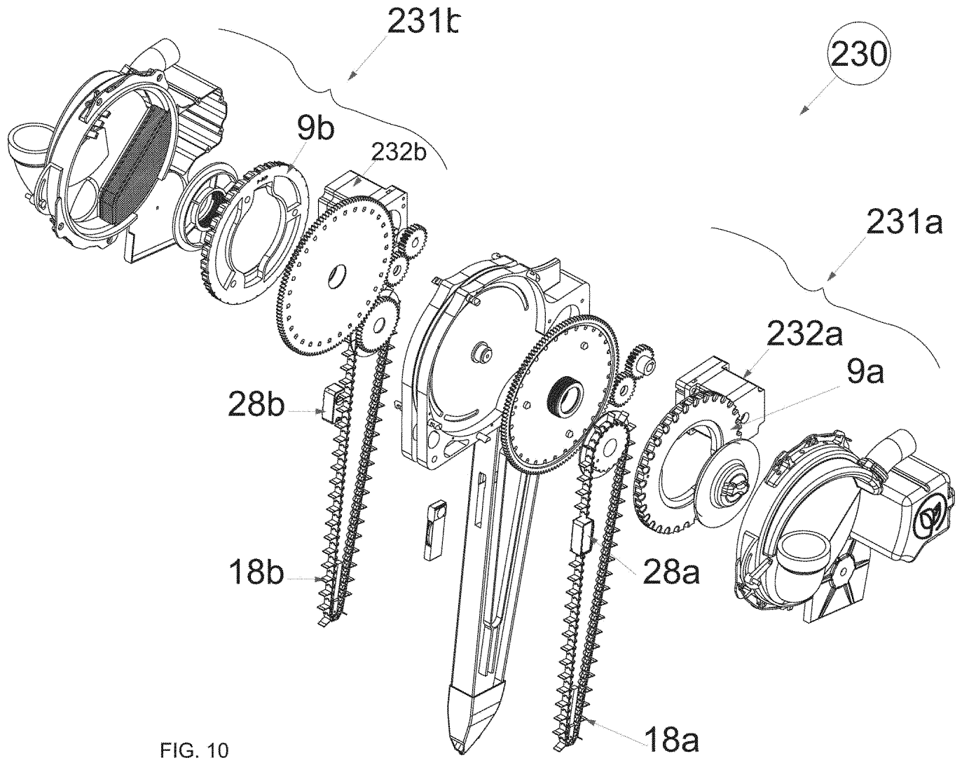

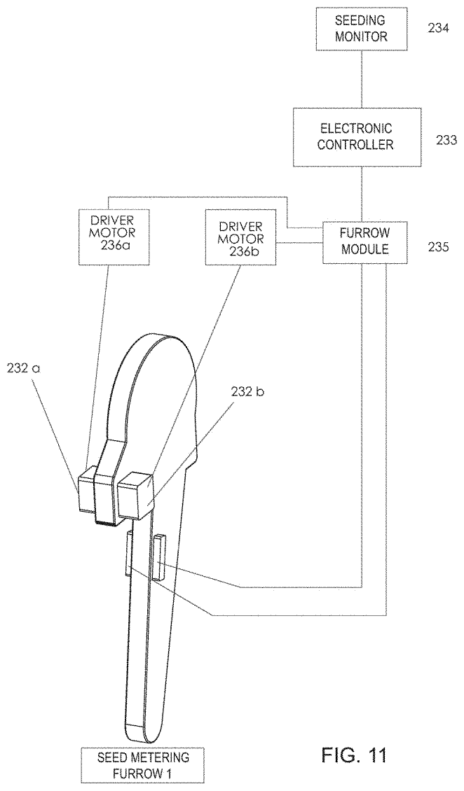

In a preferred embodiment, FIGS. 10 and 11, each seed dispensing device of the present invention can comprise control electronics to carry out the respective activation and speed control of motors, plates, sprayers, etc. In an exemplary way, but not limiting for the invention, and in order to provide greater clarity for the following description of the embodiment, reference has been made to the dispensing device of the invention in metering parts or modules A and B. As can be seen in FIG. 10, there is a seed dispensing device 230 that comprises a metering part or module 231a and another metering part or module 231b. Based on the object of this embodiment, each metering module will have rotating plates 9a-9b; sensors 28a-28b; seed conveyor chains 18a-18b; and a pair of electric drive motors 232a-232b, the latter being those that drive said rotating plates 9a-9b respectively. Although not all the elements of the dispensing device have been described or referenced, it is understood that they are part of this embodiment in accordance with what is described above in the description.

However, with respect to said control electronics, it comprises at least one electronic controller 233, at least one sowing monitor 234 and at least one furrow control module 235. The electronic controller 233 communicates with the sowing monitor 234, in which the different parameters, maps or seeding profiles, and the different furrow control modules 235 are loaded by means of serial communication of the CAN ISOBUS type and power wiring, this being not limiting of the invention.

Likewise, the electronic controller 233 is in charge of determining the operation and speed of each electric motor 232a and 232b through respective motion controllers 236a and 236b, reporting this to each furrow control module 235. In turn, the electronic controller 233 analyzes the information coming from the seed sensors 28a and 28b, the sowing monitor 234 and the maps, profiles or seed parameters that the latter has loaded. It should be noted that said sowing monitor 234 manages all the control of the sowing system and the analysis of the agronomic data loaded in the maps, profiles or parameters of sowing monitor 234. In turn, the furrow control module 235 manages the speed and positioning of the motors 232a and 232b and the information of the sensors 28a and 28b, making this module an interface between the controller 233 and the motors 232a and 232b and the seed sensors 28a and 28b.

Regarding the operation of the control electronics of the invention, it will be described below with reference to a furrow, being applicable to all furrows, wherein the metering modules 231a and 231b that make up the dispensing device of the invention are located.

At the beginning of the operation of the metering system and by way of preliminary preparation, the electronic controller 233 by means of the movement controllers 236a and 236b simultaneously rotates both electric motors 232a and 232b which move the seed loading system, being for this example, the seed loading rotating plates 9a and 9b matching a respective furrow, until the respective sensors 28a and 28b of each chain 18a-18b detect the first seed in the housing, and advance the number of positions necessary for said housing (with the seed), stay at the point prior to being released into the furrow, as explained above. This is valid for the two seed conveyor chains 18a and 18b. Thus leaving both chains 18a and 18b with their housings full of seeds ready to start work. Once these preliminary movements have been carried out, the dosing module 1a or 1b can be started.

Thus, the electronic controller 233 will start with the operation of the dosing module 1a by activating the rotation of the motor 232a that moves the rotating plate 9a, and thus the seed metering begins through the seed conveyor chain 18a. The rotational speed of the motor 232a depends on what the electronic controller 233 and motion controller 236a indicate based on the linear speed of the machine, seed density, furrow location and/or the maps, profiles or sowing parameters loaded in the sowing monitor 234. This speed data is sent to the movement controller 236a of the electric motor 232a to correctly generate its drive depending on the pre-established parameters for each type of seed or grain to be sown, and the conditions of the terrain, etc.

The work logic implemented by means of the electronic controller 233 makes that, upon detection by means of the seed sensor 28a of a lack of seed in one of the seed housings of the seed conveyor chain 18a driven by the motor 232a, an activation command or signal is sent to the motor 232b that drives the rotating plate 9b and consequently the seed conveyor chain 18b, which has seeds in each of the housings, in order to supply the missing seed of the chain 18a. After that, the plate 9b will continue rotating at the speed that corresponds to the system given by the linear speed of the machine, seed density, furrow location and/or the maps, profiles or sowing parameters loaded in the sowing monitor 234, being in practice the same as the motor 232a would have for that point on the ground. The rotating plate 9b will continue metering until there is a lack of seed in the seed housing of the chain 18b detected by the seed sensor 28b and thus an activation of the metering module 1a will occur, continuing with the sowing process continuously, without interruptions.

This logic of reaction and alternation is the same that was used in the case of the missing seed in the metering module 1a. Therefore, in the event of a missing seed in the metering module 1b, the missing seed is replaced with the aforementioned system of the metering module 1a.

Thus, the control electronics of this preferred embodiment of the invention is based on electronic modules that are in charge of, among other tasks, the control of the position and speed of rotation in the electric motors 232a and 232b corresponding to the double metering devices that dispenses the seeds in each furrow, the detection of seeds in each individual metering device by means of the seed sensors 28a and 28b, the selection of the individual metering module that will be in operation 1a or 1b according to the information determined by the seed sensors 28a and 28b and its communication to the sowing monitor controller 234 that manages all the sowing system control and the analysis of the agronomic data loaded on the maps of the sowing monitor 234.

That is, the control electronics has at least said electronic controller 233 in communication with at least said sowing monitor 234 and with said furrow module 235; wherein said sowing monitor 234 is provided with at least one sowing profile, map or parameter, the sowing operating characteristics of which are sent to said electronic controller 233 so that the latter, based on the sowing operating characteristics requested and dependent on each type of sowing, sends a corresponding signal to said furrow module 235 which will send its respective activation or drive signal to said pair of electric motors 232a-232b, each of which selectively rotates a corresponding rotating plate 9a-9b, thus allowing the sowing process to be carried out through the corresponding actuated seed conveyor chain 18a or 18b.

Wherein, each movement controller 236a-236b is in communication with said furrow module 235 and with a corresponding electric motor, for example electronic or stepper, being that each movement controller allows to regulate the rotation speed of each motor depending on the sowing operational characteristics received from the furrow module 235 communicated with said electronic controller 233, which in turn receives the respective signal from the sowing monitor 234 based on the sowing map, profile or parameter to be used. Likewise, said furrow module 235 is in communication with said pair of seed sensors 28a-28b in order to receive a respective signal from them and thus activate an electric motor or other one depending on the given conditions.

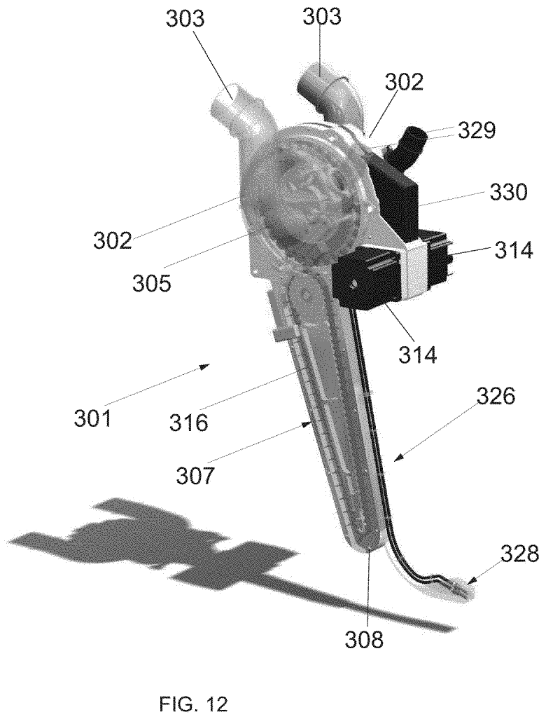

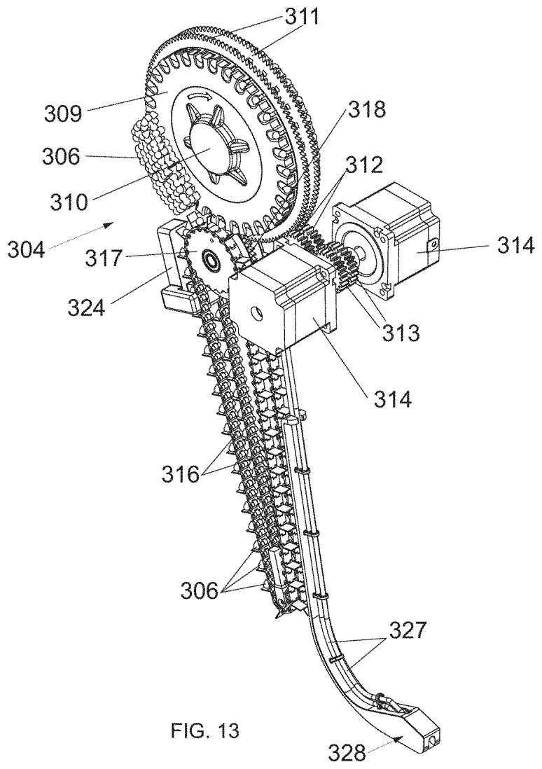

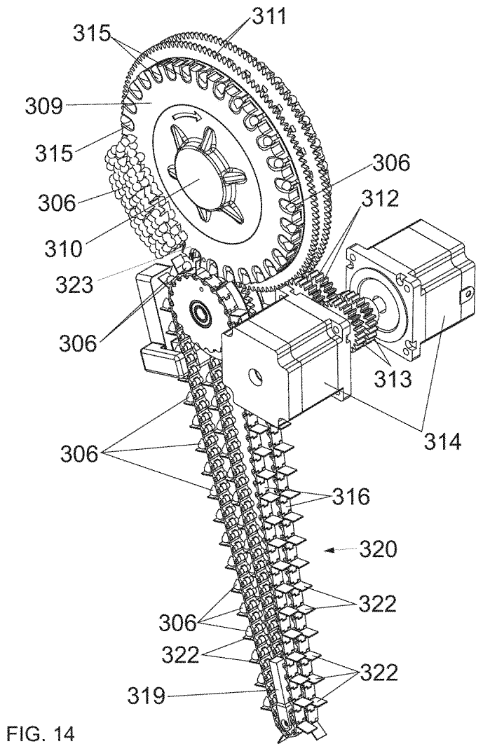

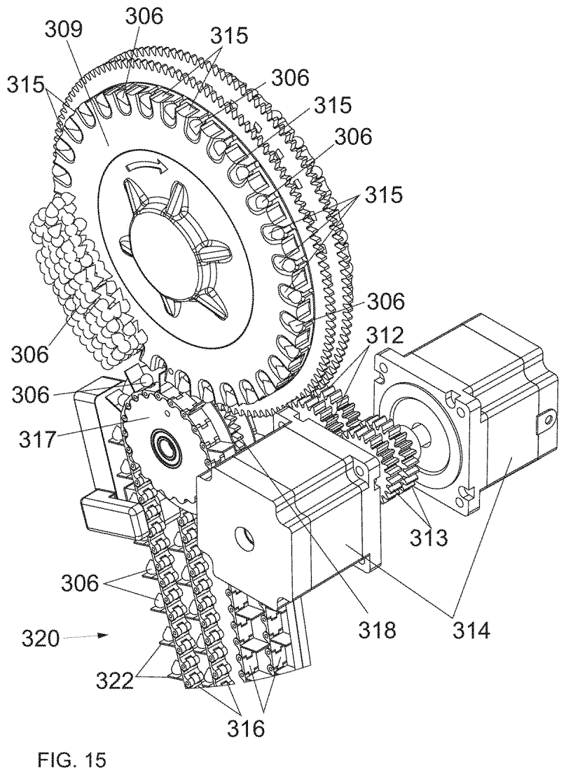

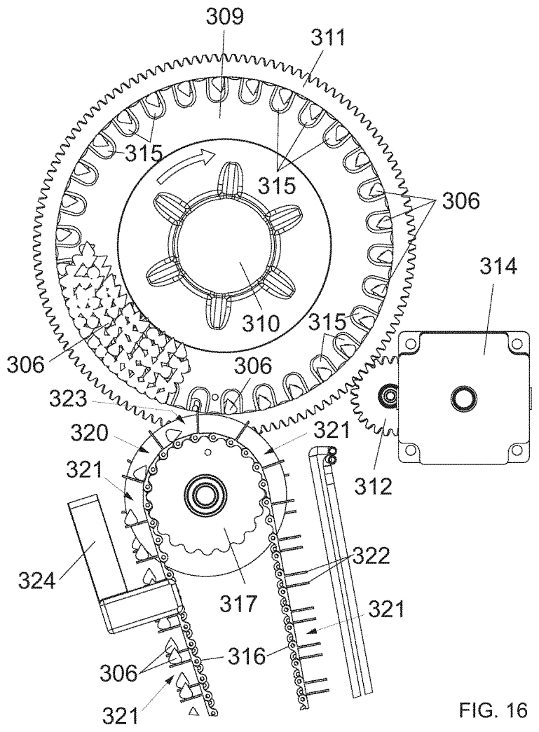

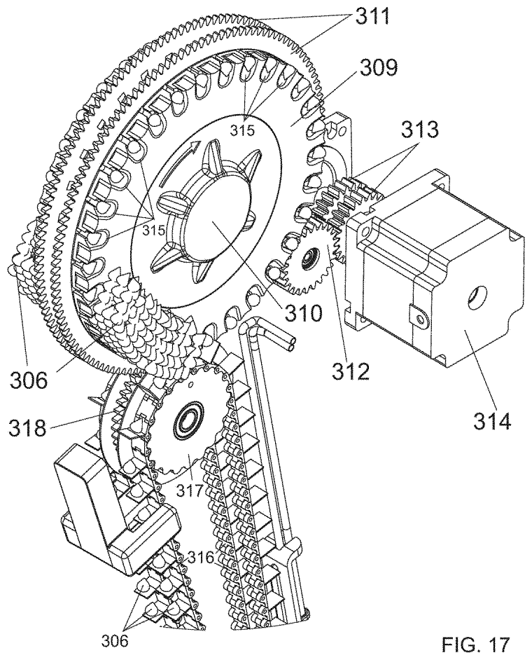

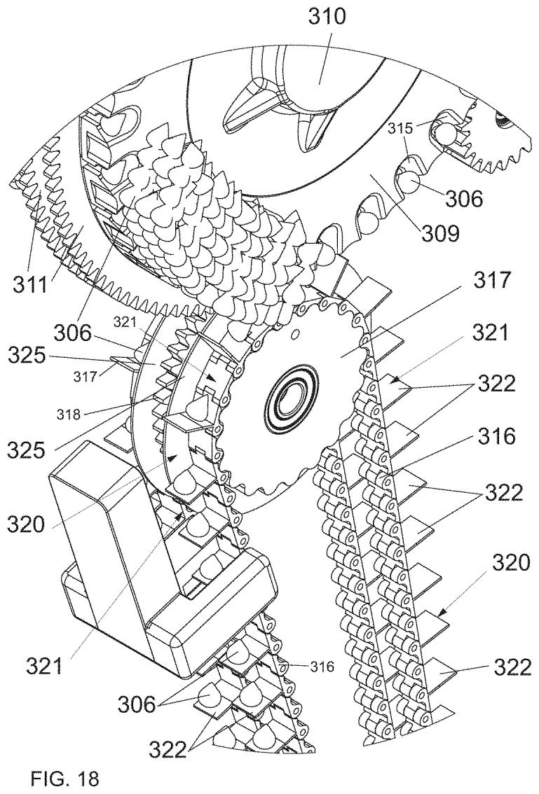

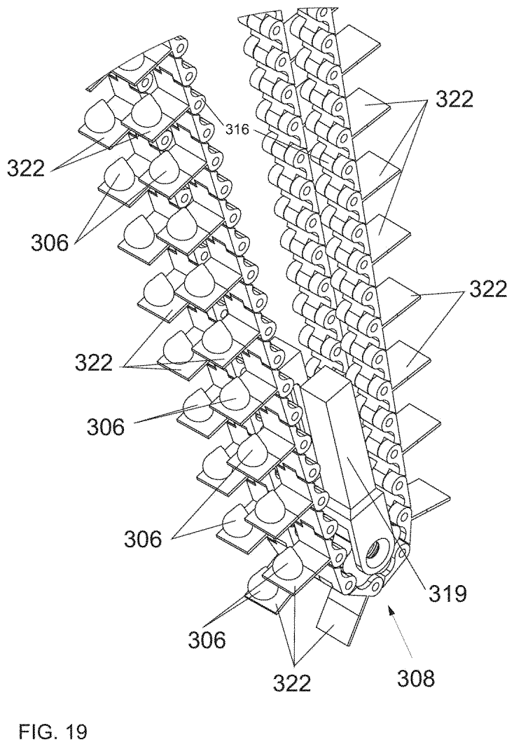

In another preferred embodiment, according to FIGS. 12 to 19, the dispensing device of the present invention is indicated by the general reference 301 and comprises respective covers 302, each of which now has at least one seed feed inlet. 303 in order to dispense the seeds more homogeneously on each side of the dispensing device and likewise there are respective air inlet ducts 329, each of which allows to generate a positive pressure inside the enclosure, being, in turn, an air outlet 330. Also, the seed dispensing device of this preferred embodiment has a more simplified metering mechanism 304 than the metering mechanism of the previous embodiment. A seed container is arranged in the lower part of the dispensing device 301 so as to accumulate seeds 306 coming from the respective inlets 303, which will then be metered through the metering mechanism 304 that takes the seeds and discharges them into a discharge conduit 307 whose outlet port 308 is oriented towards the respective furrow previously made on the surface.

In relation to the metering mechanism 304, and more particularly to the feeding mechanism, it comprises a pair of independent rotating plates 309 that are arranged in parallel, spaced apart from each other and that are driven through the rotation of a respective axis of rotation 310 which in turn, is driven through a set of central 311, intermediate 312 transmission gears and motors 313, the latter being driven by means of respective electric motors 314 commanded by an electronic arrangement such as the one mentioned in the cases of the FIGS. 10 and 11. Said central transmission gears 311 will have a diameter greater than that of the rotating plates 309, this not being limiting for the invention.

For its part, each of the rotating plates 309 has on its perimeter a plurality of containers 315 which partially receive and house a seed 306 taken from the seed container 305. The shape and dimensions of each container 315 allow the accommodation of a single seed, avoiding overfeeding that could harm the continuous sowing process.

As in the embodiment of FIGS. 1 to 11, in this embodiment there are corresponding seed conveyor chains 316 parallel and independent from each other, mounted on respective secondary gears 317, each of which in turn is connected to a secondary central gear 318 which is in contact with and operatively driven by at least one of the central transmission gears 311. The conveyor chains 316 extend in a closed-loop fashion along and inside the conduit 307 to the outlet port 308. In this preferred embodiment, the extension of the seed conveyor chains towards the outlet port 308 is guided in a closed manner inside the discharge conduit 307 through a lower guide 319. In this manner, the conveyor chains 316 move along a closed loop within the discharge conduit.

As in the previous embodiment, each conveyor chain 316 has a seed receiving face 320 which comprises a plurality of links or sections 321 for receiving seeds 306 separated or delimited by blades 322. Each of the blades 322 shall keep each seed placed in the receiving links 321 until it is discharged through the outlet port 308. It should be noted that each seed 306 rests on the respective blade 322 when it is “going down” towards the outlet port 308 The shape of each receiving link or section 321 together with the blades 322 allow for contiguous and delimited spaces to temporarily store a single seed in each of them.

Thus, when each rotating plate 309 rotates, each one of the containers 315 takes a seed 306 from the seed container 305 and rotates towards a gathering area 323 in which the seed 306 contained in the container 315 of the rotating plate 309 “falls” into a respective receiving section link 321 of the conveyor chains 316. That is, each receiving link or section 321 is going to receive and house a single seed 306. Once the seeds are placed in the receiving sections or links 321, each seed 306 is accommodated against the blade 322, remaining supported on it until its discharge through the discharge port 308. To prevent the seeds from falling from each respective receiving link 321, there are respective discoidal plates 325 arranged internally on each side of said secondary gears 317 which have a larger diameter to support the seed during its placement in the receiving links 321.

It is emphasized that, the aforementioned procedure of providing a seed in each receiving link or section 321 of the conveyor chain 316 by rotating the rotating plate 309, applies equally to both conveyor chains 316 of the dispensing device. Likewise, in order to guarantee that one seed is placed in the furrows at a time and to avoid having empty reception links 321 or with two or more seeds 306, the present invention provides a sensor 324 which senses the number of seeds in each receiving link or section 321, wherein “one” is the correct lumber of seeds in each link, and “null”, “empty”, or “two or more seeds” is the wrong number in each receiving link 321, as mentioned above in the first embodiment.

The sensor 324 may comprise a pair of sensors 324 such as sensors 28a and 28b of the first embodiment, and which are arranged adjacently on each side of each conveyor chain 316 so as to sense links 321 of both of them. When detecting that a receiving link 321 is empty or with two or more seeds of the conveyor chain that is in operation at that moment, the sensor sends the corresponding signal to stop it and start the activation of the other conveyor chain which already has a seed in a position adjacent to the discharge port to be able to be discharged continuously with the discharge already started and thus not interrupting the rhythm of placement or metering of seeds.

Once the second chain is in operation, the sensor sends another simultaneous signal so that the conveyor chain that had an empty receiving link or with two or more seeds, gradually moves until it positions a receiving link 321 that has one single seed 306 adjacent to the discharge port 308 and thus being able to continue with the discharge of seeds in the event that the current conveyor chain in operation presents an empty link or with two or more seeds. That is, each of said at least two parallel and independent seed conveyor chains is provided with a seed in each of its links, and when the chain that is in operation does not have seeds in one of its links, it is stopped and the other seed conveyor chain is activated so that it begins to unload the seed that is already housed in a position adjacent to the outlet port and thus continuing with the sowing process.

Although it has been mentioned that a link can present two or more seeds and that this implies an arrest of the respective chain, in practice, this third alternative has shown a low probability that the aforementioned situation may occur.

It is clarified that the operation of the conveyor chains is the same as that of the previous embodiment, with its characteristics, functionalities and modes of operation already described, except for the use of rotating blades 29 which are not present in this embodiment, and that for such reasons no further descriptive details will be included. Likewise, the same electronic arrangement of FIGS. 10 and 11 can be used for the present embodiment without any inconvenience, its mode of operation being already described above.

On the other hand, the present preferred embodiment comprises a spray arrangement 326 provided with two spray tubes 327 which have one end connected to a spray liquid tank and another end 328 that defines a spray liquid ejection nozzle to spray the area adjacent to the seed in the furrow. The spray arrangement is going to be operatively communicated to a control unit that will emit the respective signals for activating the nozzles, as occurs in the previous embodiments.

On the other hand, by means of the present invention a concept is generated that arises from being able to “count” seeds through the sensors and to be able to detect a jammed seed. This is due to the fact that if during a given time the respective sensor detects a lack of seed in a number that is a multiple of the number of seed housings that the rotating plate 309 has, it can be assumed that this “periodic” lack in the chain is due to the seed being stuck in some hole/housing on the rotating plate. By means of this “count” made by the sensor, a jammed seed alert can be established or given.

In this way, the present invention can be adapted without any inconvenience, to be equipped in precision seeders being able to work with fine grains and coarse grains, also being possible to dispense hybrids due to the design of the loading hopper and the electronic control of the computerized central unit.

I claim:

1. A seed dispensing device for sowing machines, comprising:
a seed feeding inlet in communication with a seed container capable of housing seeds to be sown into a furrow previously made on a seeding surface;
a seed metering device in communication with a discharge conduit, the discharge conduit having an outlet port which is oriented towards said furrow,
at least two parallel and independent seed conveyor chains, each one of the at least two parallel and independent seed conveyor chains being mounted on a corresponding independent central gear, with each one of the at least two parallel and independent seed conveyor chains forming a closed loop, wherein the at least two parallel and independent seed conveyor chains being adjacent to each other to extend, along a part of the closed loop, within the discharge conduit up to the outlet port of the discharge conduit,
at least one pair of seed sensors; each seed sensor of said at least one pair of seed sensors arranged adjacent to a respective one of each side of said at least two parallel and independent seed conveyor chains, with each seed sensor being capable of detecting presence of seeds in said at least two parallel and independent seed conveyor chains,
at least one electronic controller in communication with at least one sowing monitor and with a furrow module;
wherein said sowing monitor is provided with at least one sowing profile, map or parameter, whose sowing operating characteristics are sent to said electronic controller so that the latter, based on the sowing operating characteristics requested and dependent on each type of seeding, sends a corresponding signal to said furrow module which will send its respective activation or drive signal to a pair of electric motors, each of which selectively rotates a corresponding rotating plate, thus allowing to carry out the process of sowing through the corresponding driven seed conveyor chain, and
wherein said discharge conduit is provided with seeds by said at least two parallel and independent seed conveyor chains in a manner that when one of said at least two parallel and independent seed conveyor chains has no seed in a position at said outlet port, the other one of said at least two parallel and independent seed conveyor chains discharges the seed housed in the other one of said at least two parallel and independent seed conveyor chains.

2. The seed dispensing device of claim 1, wherein said at least two parallel and independent seed conveyor chains are guided towards the discharge conduit through two guide rollers.

3. The seed dispensing device of claim 2, wherein said at least two parallel and independent seed conveyor chains are guided towards the outlet port and inside the discharge conduit through a roller, a lower guide or a combination thereof.

4. The seed dispensing device of claim 1, further comprising overfilled seed ejectors, wherein the overfilled seed ejectors are selected between rotating blades and electric seed ejecting actuators, arranged on each side of the at least two parallel and independent seed conveyor chains and below the seed sensors, said rotating blades being driven by an electric motor.

5. The seed dispensing device of claim 4, wherein said seed sensors and electric motor are connected to a computerized central unit.

6. The seed dispensing device of claim 1, wherein said at least two parallel and independent seed conveyor chains are fed with seeds by a feeder device comprising a pair of rotating plates independent from each other which are driven through a respective rotating shaft which in turn, is driven through an electric motor,
a plurality of arms radially arranged on the perimeter of each rotating plate, which have a distal end provided with at least one means of collecting seeds, and
at least a pair of secondary conduits having a metered seed inlet and a metered seed outlet which is oriented towards the respective at least two parallel and independent seed conveyor chain.

7. The seed dispensing device of claim 6, wherein said independent central gears on which said at least two parallel and independent seed conveyor chains engage are rotably mounted between said rotating plates and are driven by means of the corresponding rotating shaft.

8. A seed dispensing device according to claim 6, wherein said gears on which the at least two independent and parallel seed conveyor chains engage are secondary gears.

9. seed dispensing device according to claim 8, wherein said secondary gears where the at least two parallel and independent seed conveyor chains engage, are driven by respective central transmission gears which drive said drive shaft and are driven by means of respective intermediate transmission gears—motor gears, the latter being connected to respective electric motors.

10. The seed dispensing device of claim 7, wherein said at least one means of collecting seeds comprises a window or access port that extends forming a container which receives a seed from the seed container.

11. The seed dispensing device of claim 10, wherein said secondary conduits are arranged inclined above the central gears, and each access window or port of said at least one collecting means passes adjacent thereto, while each metered seed outlet is oriented adjacent to a seed receiving face of each one of the at least two parallel and independent seed conveyor chain.

12. The seed dispensing device of claim 11, further comprising a pair of curved seed guides extending each from the metered seed inlet of the secondary conduit to a lower portion in a circumferential manner, being in operative contact with the seeds deposited on the seed collecting means whose access ports or windows pass in a flush manner to said seed guides.

13. The seed dispensing device of claim 12, wherein said seed receiving face comprises a plurality of wedge-shaped sections or links which central portion is provided with a seed receiving seat.

14. A seed dispensing device according to claim 10, wherein said seed receiving face comprises a plurality of links or receiving sections delimited by respective blades.

15. The seed dispensing device of claim 1, further comprising a seed spraying system for spraying a treating product onto each seed that is being dispensed, the seed spraying system comprising at least two product conveying conduits extending close to the at least two parallel and independent seed conveyor chains and from an upper portion of the seed dispensing device up to the outlet port of the discharge conduit, each product conveying conduit including an electro-valve between an upper end connected to a product container and a lower end including at least an ejecting nozzle.

16. A seed dispensing device according to claim 15, wherein a central computerized unit activates the corresponding solenoid valve that in turn activates the corresponding ejection nozzle to spray each seed that is being discharged.

17. A seed dispensing device according to claim 1, which also comprises a pair of motion controllers, each of which is in communication with said furrow module and with a corresponding electric motor, with each movement controller allowing to regulate the rotation speed of each electric motor depending on the sowing operating characteristics received from the furrow module communicated with said electronic controller, which in turn receives the respective signal from the sowing monitor based on the sowing map, profile or parameter to be used.

18. A seed dispensing device according to claim 17, wherein said groove module is in communication with said pair of seed sensors in order to receive a respective signal from these and thus activate an electric motor or other one depending on the given conditions.
